(19) United States
(12) Patent Application Publication
(10) Pub. No.: US 2026/0172808 A1
(43) Pub. Date: Jun. 18, 2026

(54) SERVICE BASED PLMN SELECTION AND REGISTRATION FOR CELLULAR DEVICE & NETWORK

(71) Applicant: Apple Inc., Cupertino, CA (US)

(72) Inventors: Xiangpeng JING, Saratoga, CA (US); Sridhar PRAKASAM, Fremont, CA (US); Lester K. CHAN, Cupertino, CA (US); Vivek G. GUPTA, San Jose, CA (US); Karthik ANANTHARAMAN, Cupertino, CA (US)

(21) Appl. No.: 19/126,573

(22) PCT Filed: Oct. 11, 2023
(86) PCT No.: PCT/US2023/076623

§ 371 Date: May 1, 2025

Related U.S. Application Data
(60) Provisional application No. 63/421,497, filed on Nov. 1, 2022.

(51) Int. Cl. H04W 8/18; H04L 65/1016; H04W 84/04

(52) U.S. Cl. CPC H04W 8/18; H04L 65/1016; H04W 84/042

(57) ABSTRACT

Methods and apparatuses are disclosed for use in a communication network to implement service-based public land mobile network (PLMN) selection and registration for a user equipment (UE). In one example embodiment, a UE may be configured to implement operations including: determining a service to request from an application; performing a PLMN selection from a service-based PLMN list of a SIM card; and based on the PLMN selection, proceeding with the service with the selected PLMN.

### FIELD OF INVENTION

This invention relates generally to the field of wireless communication, and more particularly, to methods and apparatuses used in a communication network to implement service-based public land mobile network (PLMN) selection and registration for a user equipment (UE).

### BACKGROUND OF THE INVENTION

In a wireless communications network, a user equipment (UE) may communicate with a base station of the network by establishing a radio link between the UE and the base station and communicate with the network. For example, in various wireless networks (implemented with 5G (NR), 4G (LTE), 3GPP, etc.), a UE may receive signaling and data from the serving base station in a downlink transmission direction or transmit signaling and data to the serving base station in an uplink transmission direction. Based upon these radio links, UEs can wirelessly communicate with the network to implement various types of services.

There are more and more services developing for UEs that are for wearable devices or that are Internet of Thing (IoT) devices that need registration for specific services with the network. For example, cellular roaming has been introduced for wearable devices, but only for Voice over LTE (VoLTE) service roaming, and not for Circuit Switch (CS) roaming. As an example, often wearable watches only have IP multi-media subsystem (IMS) voice and short message service (SMS) roaming agreements. As other examples, stationary IoT sensors may only need SMS service supported (e.g., to periodically report sensor data), while mobile IoT tracking devices may only need location service supported. However, in standard cellular communication networks, there is a lack of an efficient way for network service discovery before registration and after reject, for these new types of services for these new types of wearable and IoT UEs, which results in excessive registration attempts and failures and bad user experience during roaming where local networks cannot support these services. This results in excessive power impact on these types of wearable and IoT UEs and increased network load and signaling.

As one example, a wearable watch with an IMS only service subscription may unnecessarily attempt all roaming networks to find an IMS roaming partner. This is problematic because the majority of public land mobile network (PLMN) roaming partners may be CS voice roaming only and cannot support the IMS service. It should be noted that many carrier networks do not have a reliable way to find a supporting network for the IMS service and there is no helpful information from the network rejection to guide the UE to find proper networks for the particular IMS service.

It would be beneficial to implement methods and processes at both the UE level and at the network level to solve these issues to provide a more efficient way for network service discovery before registration and after reject, for these new types of services for these new types of wearable and IoT UEs.

### SUMMARY OF THE DESCRIPTION

Methods and apparatuses are disclosed for use in a communication network to implement service-based public land mobile network (PLMN) selection and registration for a user equipment (UE). As will be described, methods and apparatuses are disclosed that provide a service-based PLMN priority list for mobile devices (e.g., for IMS voice, IMS SMS, location service, emergency services, etc.). The methods and apparatuses disclosed provide more granular service-based registration requests from the UE to the network and service-based registration acceptance from the network to the UE. As will be described, the methods and apparatuses implement methods and processes at both the UE level and at the network level to solve the issue that, in standard cellular communication networks, there is a lack of an efficient way for network service discovery before registration and after reject, for newer types of services (e.g., IMS voice, IMS SMS, location service, emergency services) for newer wearable and IoT UEs, which results in excessive registration attempts and failures and bad user experience during roaming where local networks cannot support these services.

In one example embodiment, a user equipment (UE) to connect to a network is described that comprises: at least one antenna; at least one radio, wherein the at least one radio is configured to communicate with the network including a base station using the at least one antenna; a SIM (Subscriber Identity Module) card including a service-based public land mobile network (PLMN) list including a priority list of PLMNs, wherein each PLMN includes one or more supported services; and at least one processor coupled to the at least one radio and the SIM card. The processor is configured to perform operations comprising: determining a service to request from an application; performing a PLMN selection from the service-based PLMN list of the SIM card; and based on the PLMN selection, proceeding with the service with the selected PLMN. In one embodiment, the PLMNs include a home PLMN (HPLMN) and visiting PLMNs (VPLMNs). In one embodiment, the supported services include at least one of a location service, an emergency call, data, IP multi-media subsystem (IMS) short message service (SMS), IMS voice, circuit switched (CS) SMS, or CS voice. In one embodiment, the UE includes: a cellular watch, a stationary or mobile internet of things (IoT) sensor, a mobile IoT tracking device, or an emergency cellular fob. In one embodiment, the processor is configured to perform the PLMN selection by matching the requested service with available supported services from the service-based public land mobile network (PLMN) priority list of the SIM card. In one embodiment, the processor is configured to perform the PLMN selection by matching the requested service with available supported services from the service-based public land mobile network (PLMN) priority list of the SIM card during an idle mode of the UE. In one embodiment, the processor is configured to perform the PLMN selection by matching the requested service with available supported services from the service-based public land mobile network (PLMN) priority list of the SIM card based upon a received network broadcast of PLMNs and before registering with a PLMN.

In another example embodiment, a method to connect a user equipment (UE) to a network is described that comprises: determining a service to request from an application; performing a public land mobile network (PLMN) selection from a service-based PLMN list of a Subscriber Identity Module (SIM) card, wherein the SIM card includes a service-based PLMN list including a priority list of PLMNs, wherein each PLMN includes one or more supported services; and based on the PLMN selection, proceeding with the service with the selected PLMN. In one embodiment, the PLMNs include a home PLMN (HPLMN) and visiting PLMNs (VPLMNs). In one embodiment, the supported services include at least one of a location service, an emergency call, data, IP multi-media subsystem (IMS) short message service (SMS), IMS voice, circuit switched (CS) SMS, or CS voice. In one embodiment the UE includes: a cellular watch, a stationary or mobile internet of things (IoT) sensor, a mobile IoT tracking device, or an emergency cellular fob. In one embodiment, performing the PLMN selection includes matching the requested service with available supported services from the service-based public land mobile network (PLMN) priority list of the SIM card. In one embodiment, the performing the PLMN selection by matching the requested service with available supported services from the service-based public land mobile network (PLMN) priority list of the SIM card occurs during an idle mode of the UE. In one embodiment, the performing the PLMN selection by matching the requested service with available supported services from the service-based public land mobile network (PLMN) priority list of the SIM card is based upon a received network broadcast of PLMNs and before registering with a PLMN.

In an additional example embodiment, a method to connect a user equipment (UE) to a network including a public land mobile network (PLMN), a home PLMN (HPLMN), and a visiting PLMN (VPLMN) is disclosed that comprises: receiving at a PLMN of the network, an information element (IE) in a registration request message from a roaming UE requesting one or more services; based upon a rejection of the services requested from the PLMN, sending by the HPLMN to the UE, a new IE of the one or more services requested that are accepted or rejected by VPLMNs, such that the UE attempts network registration with a VPLMN providing one or more of the services requested that is accepted. In one embodiment, the one or more services include at least one of a location service, an emergency call, data, IP multi-media subsystem (IMS) short message service (SMS), IMS voice, circuit switched (CS) SMS, or CS voice. Other types of services may include services for wearables, such as, entertainment devices, gaming devices, glasses, security cameras, augmented reality devices, virtual reality devices etc. It should be appreciated that any type of service for any type of UE may be covered. In one embodiment, the UE includes: a cellular watch, a stationary or mobile internet of things (IoT) sensor, a mobile IoT tracking device, or an emergency cellular fob. In one embodiment, the HPLMN maintain a database of VPLMNs with accepted or rejected services for the UE, such that the HPLMN prepares and transmits the new IE of the one or more services requested that are accepted or rejected by the VPLMNs to the UE. In one embodiment, the new IE generated by HPLMN includes roaming VPLMNs that are in the current location of the UE. In one embodiment, the new IE generated by HPLMN further includes preferred radio access technologies (RATs) for the UE and VPLMNs that are supported by roaming agreements.

In another example embodiment, a computing device of a home public land mobile network PLMN (HPLMN) to connect a user equipment (UE) to a visiting PLMN (VPLMN) is disclosed that comprises: a transceiver; and at least one processor coupled to the transceiver. The at least one processor is configured to perform operations comprising: receiving an information element (IE) in a registration request message from a roaming UE requesting one or more services that was rejected by a PLMN; and sending to the UE, a new IE of the one or more services requested that are accepted or rejected by VPLMNs, such that the UE attempts network registration with a VPLMN providing one or more of the services requested that is accepted. In one embodiment, the one or more services include at least one of a location service, an emergency call, data, IP multi-media subsystem (IMS) short message service (SMS), IMS voice, circuit switched (CS) SMS, or CS voice. In one embodiment, the UE includes: a cellular watch, a stationary or mobile internet of things (IoT) sensor, a mobile IoT tracking device, or an emergency cellular fob. Other types of devices may include entertainment devices, gaming devices, glasses, security cameras, augmented reality devices, virtual reality devices etc. It should be appreciated that any type of UE device may be covered. In one embodiment, the computing device of the HPLMN maintains a database of VPLMNs with accepted or rejected services for the UE, such that the processor performs an operations of: comparing one or more services requested by the UE with accepted or rejected services of VPLMNs accessible by the UE in the database to determine the accepted or rejected services of VPLMNs accessible by the UE; preparing a new IE of the one or more services requested that are accepted or rejected by VPLMNs accessible by the UE; and transmitting the new IE to the UE. In one embodiment, the new IE generated by HPLMN includes roaming VLPMNs that are in the current location of the UE. In one embodiment, the new IE generated by HPLMN further includes preferred radio access technologies (RATs) for the UE and VLPMNs that are supported by roaming agreements.

Other methods and apparatuses are also described.

### BRIEF DESCRIPTION OF THE DRAWINGS

The present invention is illustrated by way of example and not limitation in the figures of the accompanying drawings in which like references indicate similar elements.

FIG. 1 illustrates an example wireless communication system according to one embodiment of the disclosure.

FIG. 2 illustrates user equipment in direct communication with a base station (BS) according to one embodiment of the disclosure.

FIG. 3 illustrates an example block diagram of a UE according to one embodiment of the disclosure.

FIG. 4 illustrates an example block diagram of a BS according to one embodiment of the disclosure.

FIG. 5 illustrates an example block diagram of cellular communication circuitry according to one embodiment of the disclosure.

FIG. 6A illustrates an example diagram of a UE that includes a SOC and a smart card or SIM card that includes a service-based OPLMN file according to one embodiment of the disclosure.

FIG. 6B illustrates an example diagram of a service-based OPLMN file according to one embodiment of the disclosure.

FIG. 6C illustrates an example diagram of a PLMN supported services according to one embodiment of the disclosure.

FIG. 7 illustrates an example flow diagram of an example method for a UE to select a PLMN based on the OPLMN file of the SIM card according to one embodiment of the disclosure.

FIG. 8 illustrates an example flow diagram of an example method to connect a UE to a network according to one embodiment of the disclosure.

FIG. 9 illustrates an example diagram of a new IE that may be prepared by the HPLMN and transmitted to the UE according to one embodiment of the disclosure.

### DETAILED DESCRIPTION

In the following description, numerous specific details are set forth to provide thorough explanation of embodiments of the present invention. It will be apparent, however, to one skilled in the art, that embodiments of the present invention may be practiced without these specific details. In other instances, well-known components, structures, and techniques have not been shown in detail in order not to obscure the understanding of this description.

Reference in the specification to “some embodiments” or “an embodiment” means that a particular feature, structure, or characteristic described in connection with the embodiment can be included in at least one embodiment of the invention. The appearances of the phrase “in some embodiments” in various places in the specification do not necessarily all refer to the same embodiment.

In the following description and claims, the terms “coupled” and “connected,” along with their derivatives, may be used. It should be understood that these terms are not intended as synonyms for each other. “Coupled” is used to indicate that two or more elements, which may or may not be in direct physical or electrical contact with each other, co-operate or interact with each other. “Connected” is used to indicate the establishment of communication between two or more elements that are coupled with each other.

The processes depicted in the figures that follow, are performed by processing logic that comprises hardware (e.g., circuitry, dedicated logic, etc.), software (such as is run on a general-purpose computer system or a dedicated machine), or a combination of both. Although the processes are described below in terms of some sequential operations, it should be appreciated that some of the operations described may be performed in different order. Moreover, some operations may be performed in parallel rather than sequentially.

The terms “server,” “client,” and “device” are intended to refer generally to data processing systems rather than specifically to a particular form factor for the server, client, and/or device.

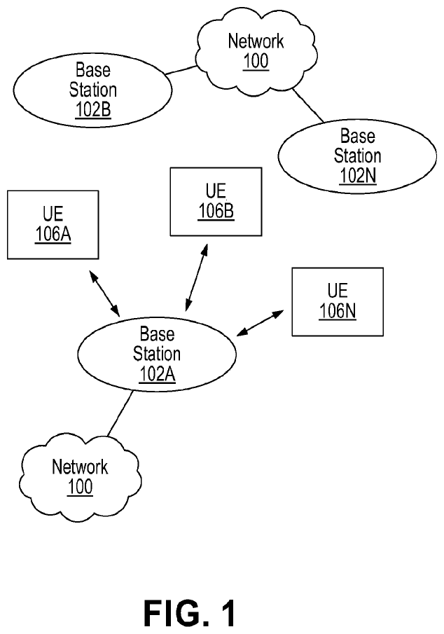

FIG. 1 illustrates a simplified example wireless communication system according to one aspect of the disclosure. It is noted that the system of FIG. 1 is merely one example of a possible system, and that features of this disclosure may be implemented in any of various systems, as desired.

As shown, the example wireless communication system includes a base station 102A which communicates over a transmission medium with one or more user devices 106A, 106B, etc., through 106N. Each of the user devices may be referred to herein as a “user equipment” (UE). Thus, the user devices 106 are referred to as UEs or UE devices.

The base station (BS) 102A may be a base transceiver station (BTS) or cell site (a “cellular base station”) and may include hardware that enables wireless communication with the UEs 106A through 106N.

The communication area (or coverage area) of the base station may be referred to as a “cell.” The base station 102A and the UEs 106 may be configured to communicate over the transmission medium using any of various radio access technologies (RATs), also referred to as wireless communication technologies, or telecommunication standards, such as GSM, UMTS (associated with, for example, WCDMA or TD-SCDMA air interfaces), LTE, LTE-Advanced (LTE-A), 5G new radio (5G NR), HSPA, 3GPP2 CDMA2000 (e.g., 1xRTT, 1xEV-DO, HRPD, eHRPD), etc. Note that if the base station 102A is implemented in the context of LTE, it may alternately be referred to as an ‘eNodeB’ or ‘eNB’. Note that if the base station 102A is implemented in the context of 5G NR, it may alternately be referred to as ‘gNodeB’ or ‘gNB’.

As shown, the base station 102A may also be equipped to communicate with a network 100 (e.g., a core network of a cellular service provider, a telecommunication network such as a public switched telephone network (PSTN), and/or the Internet, among various possibilities). Thus, the base station 102A may facilitate communication between the user devices and/or between the user devices and the network 100. In particular, the cellular base station 102A may provide UEs 106 with various telecommunication capabilities, such as voice, SMS and/or data services.

Base station 102A and other similar base stations (such as base stations 102B . . . 102N) operating according to the same or a different cellular communication standard may thus be provided as a network of cells, which may provide continuous or nearly continuous overlapping service to UEs 106A-N and similar devices over a geographic area via one or more cellular communication standards.

Thus, while base station 102A may act as a “serving cell” for UEs 106A-N as illustrated in FIG. 1, each UE 106 may also be capable of receiving signals from (and possibly within communication range of) one or more other cells (which might be provided by base stations 102B-N and/or any other base stations), which may be referred to as “neighboring cells”. Such cells may also be capable of facilitating communication between user devices and/or between user devices and the network 100. Such cells may include “macro” cells, “micro” cells, “pico” cells, and/or cells which provide any of various other granularities of service area size. For example, base stations 102A-B illustrated in FIG. 1 might be macro cells, while base station 102N might be a micro cell. Other configurations are also possible.

In some embodiments, base station 102A may be a next generation base station, e.g., a 5G New Radio (5G NR) base station, or “gNB”. In some embodiments, a gNB may be connected to a legacy evolved packet core (EPC) network and/or to a NR core (NRC) network. In addition, a gNB cell may include one or more transition and reception points (TRPs). In addition, a UE capable of operating according to 5G NR may be connected to one or more TRPs within one or more gNBs.

Note that a UE 106 may be capable of communicating using multiple wireless communication standards. For example, the UE 106 may be configured to communicate using a wireless networking (e.g., Wi-Fi) and/or peer-to-peer wireless communication protocol (e.g., Bluetooth, Wi-Fi peer-to-peer, etc.) in addition to at least one cellular communication protocol (e.g., GSM, UMTS (associated with, for example, WCDMA or TD-SCDMA air interfaces), LTE, LTE-A, 5G NR, HSPA, 3GPP2 CDMA2000 (e.g., 1xRTT, 1xEV-DO, HRPD, eHRPD), etc.). The UE 106 may also or alternatively be configured to communicate using one or more global navigational satellite systems (GNSS, e.g., GPS or GLONASS), one or more mobile television broadcasting standards (e.g., ATSC-M/H or DVB-H), and/or any other wireless communication protocol, if desired. Other combinations of wireless communication standards (including more than two wireless communication standards) are also possible.

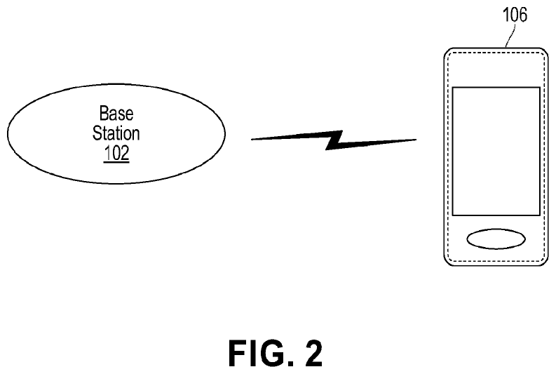

FIG. 2 illustrates a UE 106 in direct communication with a base station 102 through uplink and downlink communications according to one aspect of the disclosure. The UE 106 may be a device with cellular communication capability such as a mobile phone, a hand-held device, a computer or a tablet, or virtually any type of wireless device. The UE 106 may include a processor that is configured to execute program instructions stored in memory. The UE 106 may perform any of the method embodiments described herein by executing such stored instructions. Alternatively, or in addition, the UE 106 may include a programmable hardware element such as an FPGA (field-programmable gate array) that is configured to perform any of the method embodiments described herein, or any portion of any of the method embodiments described herein.

The UE 106 may include one or more antennas for communicating using one or more wireless communication protocols or technologies. In some embodiments, the UE 106 may be configured to communicate using, for example, CDMA2000 (1xRTT/1xEV-DO/HRPD/eHRPD) or LTE using a single shared radio and/or GSM or LTE using the single shared radio. The shared radio may couple to a single antenna, or may couple to multiple antennas (e.g., for MIMO) for performing wireless communications. In general, a radio may include any combination of a baseband processor, analog RF signal processing circuitry (e.g., including filters, mixers, oscillators, amplifiers, etc.), or digital processing circuitry (e.g., for digital modulation as well as other digital processing). Similarly, the radio may implement one or more receive and transmit chains using the aforementioned hardware. For example, the UE 106 may share one or more parts of a receive and/or transmit chain between multiple wireless communication technologies, such as those discussed above.

In some embodiments, the UE 106 may include separate transmit and/or receive chains (e.g., including separate antennas and other radio components) for each wireless communication protocol with which it is configured to communicate. As a further possibility, the UE 106 may include one or more radios which are shared between multiple wireless communication protocols, and one or more radios which are used exclusively by a single wireless communication protocol. For example, the UE 106 might include a shared radio for communicating using either of LTE or 5G NR (or LTE or 1xRTT or LTE or GSM), and separate radios for communicating using each of Wi-Fi and Bluetooth. Other configurations are also possible.

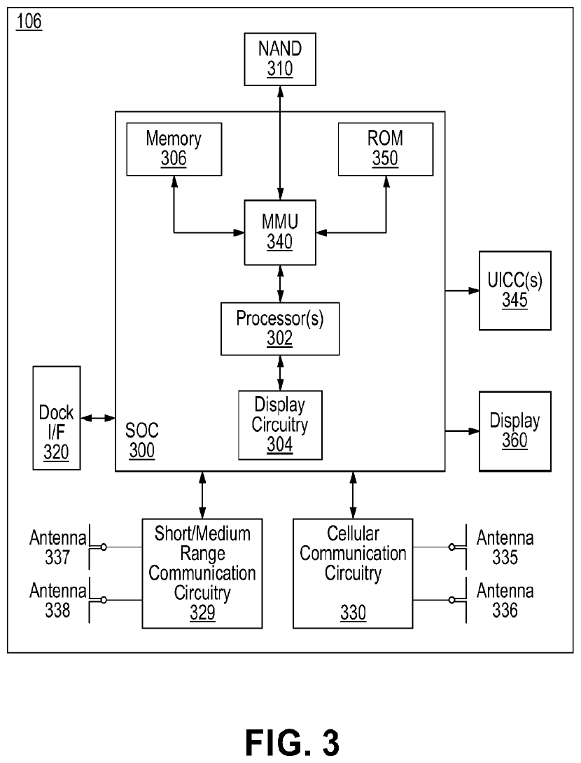

FIG. 3 illustrates an example simplified block diagram of a communication device 106 according to one aspect of the disclosure. It is noted that the block diagram of the communication device of FIG. 3 is only one example of a possible communication device. According to embodiments, communication device 106 may be a user equipment (UE) device, a mobile device or mobile station, a wireless device or wireless station, a desktop computer or computing device, a mobile computing device (e.g., a laptop, notebook, or portable computing device), a tablet and/or a combination of devices, among other devices. As shown, the communication device 106 may include a set of components 300 configured to perform core functions. For example, this set of components may be implemented as a system on chip (SOC), which may include portions for various purposes. Alternatively, this set of components 300 may be implemented as separate components or groups of components for the various purposes. The set of components 300 may be coupled (e.g., communicatively; directly or indirectly) to various other circuits of the communication device 106.

For example, the communication device 106 may include various types of memory (e.g., including NAND flash 310), an input/output interface such as connector I/F 320 (e.g., for connecting to a computer system; dock; charging station; input devices, such as a microphone, camera, keyboard; output devices, such as speakers; etc.), the display 360, which may be integrated with or external to the communication device 106, and cellular communication circuitry 330 such as for 5G NR, LTE, GSM, etc., and short to medium range wireless communication circuitry 329 (e.g., Bluetooth™ and WLAN circuitry). In some embodiments, communication device 106 may include wired communication circuitry (not shown), such as a network interface card, e.g., for Ethernet.

The cellular communication circuitry 330 may couple (e.g., communicatively; directly or indirectly) to one or more antennas, such as antennas 335 and 336 as shown. The short to medium range wireless communication circuitry 329 may also couple (e.g., communicatively; directly or indirectly) to one or more antennas, such as antennas 337 and 338 as shown. Alternatively, the short to medium range wireless communication circuitry 329 may couple (e.g., communicatively; directly or indirectly) to the antennas 335 and 336 in addition to, or instead of, coupling (e.g., communicatively; directly or indirectly) to the antennas 337 and 338. The short to medium range wireless communication circuitry 329 and/or cellular communication circuitry 330 may include multiple receive chains and/or multiple transmit chains for receiving and/or transmitting multiple spatial streams, such as in a multiple-input multiple output (MIMO) configuration.

In some embodiments, as further described below, cellular communication circuitry 330 may include dedicated receive chains (including and/or coupled to, e.g., communicatively; directly or indirectly. dedicated processors and/or radios) for multiple radio access technologies (RATs) (e.g., a first receive chain for LTE and a second receive chain for 5G NR). In addition, in some embodiments, cellular communication circuitry 330 may include a single transmit chain that may be switched between radios dedicated to specific RATs. For example, a first radio may be dedicated to a first RAT, e.g., LTE, and may be in communication with a dedicated receive chain and a transmit chain shared with an additional radio, e.g., a second radio that may be dedicated to a second RAT, e.g., 5G NR, and may be in communication with a dedicated receive chain and the shared transmit chain.

The communication device 106 may also include and/or be configured for use with one or more user interface elements. The user interface elements may include any of various elements, such as display 360 (which may be a touchscreen display), a keyboard (which may be a discrete keyboard or may be implemented as part of a touchscreen display), a mouse, a microphone and/or speakers, one or more cameras, one or more buttons, and/or any of various other elements capable of providing information to a user and/or receiving or interpreting user input.

The communication device 106 may further include one or more smart cards 345 that include SIM (Subscriber Identity Module) functionality, such as one or more UICC(s) (Universal Integrated Circuit Card(s)) cards 345.

As shown, the SOC 300 may include processor(s) 302, which may execute program instructions for the communication device 106 and display circuitry 304, which may perform graphics processing and provide display signals to the display 360. The processor(s) 302 may also be coupled to memory management unit (MMU) 340, which may be configured to receive addresses from the processor(s) 302 and translate those addresses to locations in memory (e.g., memory 306, read only memory (ROM) 350, NAND flash memory 310) and/or to other circuits or devices, such as the display circuitry 304, short range wireless communication circuitry 229, cellular communication circuitry 330, connector I/F 320, and/or display 360. The MMU 340 may be configured to perform memory protection and page table translation or set up. In some embodiments, the MMU 340 may be included as a portion of the processor(s) 302.

As noted above, the communication device 106 may be configured to communicate using wireless and/or wired communication circuitry. The communication device 106 may also be configured to determine a physical downlink shared channel scheduling resource for a user equipment device and a base station. Further, the communication device 106 may be configured to group and select CCs (component carriers) from the wireless link and determine a virtual CC from the group of selected CCs. The wireless device may also be configured to perform a physical downlink resource mapping based on an aggregate resource matching patterns of groups of CCs.

As described herein, the communication device 106 may include hardware and software components for implementing the above features for determining a physical downlink shared channel scheduling resource for a communications device 106 and a base station. The processor 302 of the communication device 106 may be configured to implement part or all of the features described herein, e.g., by executing program instructions stored on a memory medium (e.g., a non-transitory computer-readable memory medium). Alternatively, (or in addition), processor 302 may be configured as a programmable hardware element, such as an FPGA (Field Programmable Gate Array), or as an ASIC (Application Specific Integrated Circuit). Alternatively, (or in addition), the processor 302 of the communication device 106, in conjunction with one or more of the other components 300, 304, 306, 310, 320, 329, 330, 340, 345, 350, 360 may be configured to implement part or all of the features described herein.

In addition, as described herein, processor 302 may include one or more processing elements. Thus, processor 302 may include one or more integrated circuits (ICs) that are configured to perform the functions of processor 302. In addition, each integrated circuit may include circuitry (e.g., first circuitry, second circuitry, etc.) configured to perform the functions of processor(s) 302.

Further, as described herein, cellular communication circuitry 330 and short range wireless communication circuitry 329 may each include one or more processing elements. In other words, one or more processing elements may be included in cellular communication circuitry 330 and, similarly, one or more processing elements may be included in short range wireless communication circuitry 329. Thus, cellular communication circuitry 330 may include one or more integrated circuits (ICs) that are configured to perform the functions of cellular communication circuitry 330. In addition, each integrated circuit may include circuitry (e.g., first circuitry, second circuitry, etc.) configured to perform the functions of cellular communication circuitry 230. Similarly, the short range wireless communication circuitry 329 may include one or more ICs that are configured to perform the functions of short range wireless communication circuitry 32. In addition, each integrated circuit may include circuitry (e.g., first circuitry, second circuitry, etc.) configured to perform the functions of short range wireless communication circuitry 329.

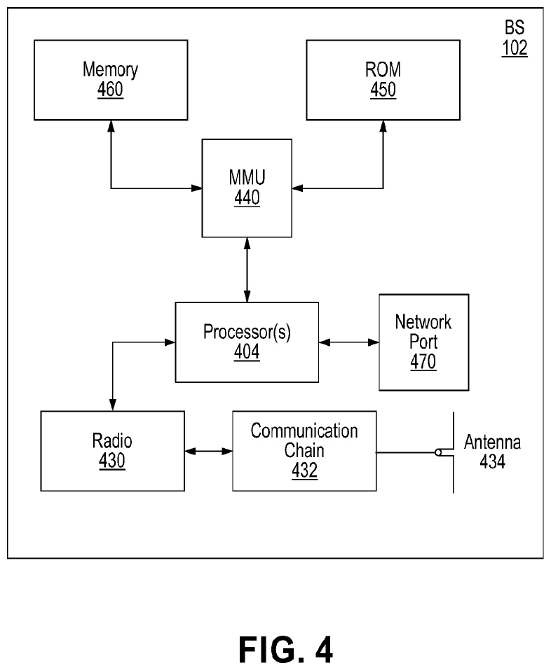

FIG. 4 illustrates an example block diagram of a base station 102 according to one aspect of the disclosure. It is noted that the base station of FIG. 4 is merely one example of a possible base station. As shown, the base station 102 may include processor(s) 404 which may execute program instructions for the base station 102. The processor(s) 404 may also be coupled to memory management unit (MMU) 440, which may be configured to receive addresses from the processor(s) 404 and translate those addresses to locations in memory (e.g., memory 460 and read only memory (ROM) 450) or to other circuits or devices.

The base station 102 may include at least one network port 470. The network port 470 may be configured to couple to a telephone network and provide a plurality of devices, such as UEs 106, access to the telephone network as described above in FIGS. 1 and 2.

The network port 470 (or an additional network port) may also or alternatively be configured to couple to a cellular network, e.g., a core network of a cellular service provider. The core network may provide mobility related services and/or other services to a plurality of devices, such as UEs 106. In some cases, the network port 470 may couple to a telephone network via the core network, and/or the core network may provide a telephone network (e.g., among other UEs serviced by the cellular service provider).

In some embodiments, base station 102 may be a next generation base station, e.g., a 5G New Radio (5G NR) base station, or “gNB”. In such embodiments, base station 102 may be connected to a legacy evolved packet core (EPC) network and/or to a NR core (NRC) network. In addition, base station 102 may be considered a 5G NR cell and may include one or more transition and reception points (TRPs). In addition, a UE capable of operating according to 5G NR may be connected to one or more TRPs within one or more gNBs.

The base station 102 may include at least one antenna 434, and possibly multiple antennas. The at least one antenna 434 may be configured to operate as a wireless transceiver and may be further configured to communicate with UEs 106 via radio 430. The antenna 434 communicates with the radio 430 via communication chain 432. Communication chain 432 may be a receive chain, a transmit chain or both. The radio 430 may be configured to communicate via various wireless communication standards, including, but not limited to, 5G NR, LTE, LTE-A, GSM, UMTS, CDMA2000, Wi-Fi, etc.

The base station 102 may be configured to communicate wirelessly using multiple wireless communication standards. In some instances, the base station 102 may include multiple radios, which may enable the base station 102 to communicate according to multiple wireless communication technologies. For example, as one possibility, the base station 102 may include an LTE radio for performing communication according to LTE as well as a 5G NR radio for performing communication according to 5G NR. In such a case, the base station 102 may be capable of operating as both an LTE base station and a 5G NR base station. As another possibility, the base station 102 may include a multi-mode radio which is capable of performing communications according to any of multiple wireless communication technologies (e.g., 5G NR and Wi-Fi, LTE and Wi-Fi, LTE and UMTS, LTE and CDMA2000, UMTS and GSM, etc.).

As described further subsequently herein, the BS 102 may include hardware and software components for implementing or supporting implementation of features described herein. The processor 404 of the base station 102 may be configured to implement or support implementation of part or all of the methods described herein, e.g., by executing program instructions stored on a memory medium (e.g., a non-transitory computer-readable memory medium). Alternatively, the processor 404 may be configured as a programmable hardware element, such as an FPGA (Field Programmable Gate Array), or as an ASIC (Application Specific Integrated Circuit), or a combination thereof. Alternatively, (or in addition), the processor 404 of the BS 102, in conjunction with one or more of the other components 430, 432, 434, 440, 450, 460, 470 may be configured to implement or support implementation of part or all of the features described herein.

In addition, as described herein, processor(s) 404 may be comprised of one or more processing elements. In other words, one or more processing elements may be included in processor(s) 404. Thus, processor(s) 404 may include one or more integrated circuits (ICs) that are configured to perform the functions of processor(s) 404. In addition, each integrated circuit may include circuitry (e.g., first circuitry, second circuitry, etc.) configured to perform the functions of processor(s) 404.

Further, as described herein, radio 430 may be comprised of one or more processing elements. In other words, one or more processing elements may be included in radio 430. Thus, radio 430 may include one or more integrated circuits (ICs) that are configured to perform the functions of radio 430. In addition, each integrated circuit may include circuitry (e.g., first circuitry, second circuitry, etc.) configured to perform the functions of radio 430.

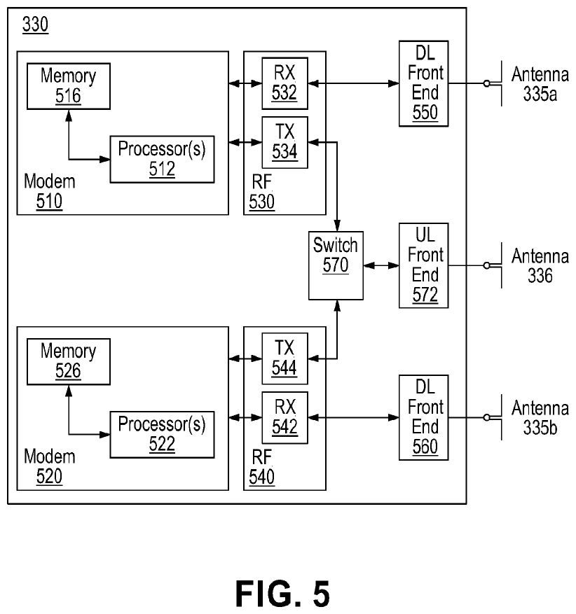

FIG. 5 illustrates an example simplified block diagram of cellular communication circuitry according to one aspect of the disclosure. It is noted that the block diagram of the cellular communication circuitry of FIG. 5 is only one example of a possible cellular communication circuit. According to embodiments, cellular communication circuitry 330 may be included in a communication device, such as communication device 106 described above. As noted above, communication device 106 may be a user equipment (UE) device, a mobile device or mobile station, a wireless device or wireless station, a desktop computer or computing device, a mobile computing device (e.g., a laptop, notebook, or portable computing device), a tablet and/or a combination of devices, among other devices.

The cellular communication circuitry 330 may couple (e.g., communicatively; directly or indirectly) to one or more antennas, such as antennas 335a-b and 336 as shown (in FIG. 3). In some embodiments, cellular communication circuitry 330 may include dedicated receive chains (including and/or coupled to, e.g., communicatively; directly or indirectly. dedicated processors and/or radios) for multiple RATs (e.g., a first receive chain for LTE and a second receive chain for 5G NR). For example, as shown in FIG. 5, cellular communication circuitry 330 may include a modem 510 and a modem 520. Modem 510 may be configured for communications according to a first RAT, e.g., such as LTE or LTE-A, and modem 520 may be configured for communications according to a second RAT, e.g., such as 5G NR.

As shown, modem 510 may include one or more processors 512 and a memory 516 in communication with processors 512. Modem 510 may be in communication with a radio frequency (RF) front end 530. RF front end 530 may include circuitry for transmitting and receiving radio signals. For example, RF front end 530 may include receive circuitry (RX) 532 and transmit circuitry (TX) 534. In some embodiments, receive circuitry 532 may be in communication with downlink (DL) front end 550, which may include circuitry for receiving radio signals via antenna 335a.

Similarly, modem 520 may include one or more processors 522 and a memory 526 in communication with processors 522. Modem 520 may be in communication with an RF front end 540. RF front end 540 may include circuitry for transmitting and receiving radio signals. For example, RF front end 540 may include receive circuitry 542 and transmit circuitry 544. In some embodiments, receive circuitry 542 may be in communication with DL front end 560, which may include circuitry for receiving radio signals via antenna 335b.

In some embodiments, a switch 570 may couple transmit circuitry 534 to uplink (UL) front end 572. In addition, switch 570 may couple transmit circuitry 544 to UL front end 572. UL front end 572 may include circuitry for transmitting radio signals via antenna 336. Thus, when cellular communication circuitry 330 receives instructions to transmit according to the first RAT (e.g., as supported via modem 510), switch 570 may be switched to a first state that allows modem 510 to transmit signals according to the first RAT (e.g., via a transmit chain that includes transmit circuitry 534 and UL front end 572). Similarly, when cellular communication circuitry 330 receives instructions to transmit according to the second RAT (e.g., as supported via modem 520), switch 570 may be switched to a second state that allows modem 520 to transmit signals according to the second RAT (e.g., via a transmit chain that includes transmit circuitry 544 and UL front end 572).

As described herein, the modem 510 may include hardware and software components for implementing the above features or for selecting a periodic resource part for a user equipment device and a base station, as well as the various other techniques described herein. The processors 512 may be configured to implement part or all of the features described herein, e.g., by executing program instructions stored on a memory medium (e.g., a non-transitory computer-readable memory medium). Alternatively, (or in addition), processor 512 may be configured as a programmable hardware element, such as an FPGA (Field Programmable Gate Array), or as an ASIC (Application Specific Integrated Circuit). Alternatively, (or in addition), the processor 512, in conjunction with one or more of the other components 530, 532, 534, 550, 570, 572, 335 and 336 may be configured to implement part or all of the features described herein.

In addition, as described herein, processors 512 may include one or more processing elements. Thus, processors 512 may include one or more integrated circuits (ICs) that are configured to perform the functions of processors 512. In addition, each integrated circuit may include circuitry (e.g., first circuitry, second circuitry, etc.) configured to perform the

As described herein, the modem 520 may include hardware and software components for implementing the above features for selecting a periodic resource on a wireless link between a UE and a base station, as well as the various other techniques described herein. The processors 522 may be configured to implement part or all of the features described herein, e.g., by executing program instructions stored on a memory medium (e.g., a non-transitory computer-readable memory medium). Alternatively, (or in addition), processor 522 may be configured as a programmable hardware element, such as an FPGA (Field Programmable Gate Array), or as an ASIC (Application Specific Integrated Circuit). Alternatively, (or in addition), the processor 522, in conjunction with one or more of the other components 540, 542, 544, 550, 570, 572, 335 and 336 may be configured to implement part or all of the features described herein.

In addition, as described herein, processors 522 may include one or more processing elements. Thus, processors 522 may include one or more integrated circuits (ICs) that are configured to perform the functions of processors 522. In addition, each integrated circuit may include circuitry (e.g., first circuitry, second circuitry, etc.) configured to perform the functions of processors 522.

Methods and apparatuses are disclosed for use in communication network 100 to implement service-based public land mobile network (PLMN) selection and registration for a user equipment (UE) 106. As will be described, methods and apparatuses are disclosed that provide a service-based PLMN priority list for UEs 106 (e.g., for IMS voice, IMS SMS, location service, emergency services, etc.). The methods and apparatuses disclosed provide more granular service-based registration requests from the UE 106 to the network 100 and service-based registration acceptance from the network 100 to the UE 106. As will be described, the methods and apparatuses implement methods and processes at both the UE level and at the network level to solve the issue that, in standard cellular communication networks, there is a lack of an efficient way for network service discovery before registration and after reject, for newer types of services (e.g., IMS voice, IMS SMS, location service, emergency services) for newer wearable and IoT UEs, which results in excessive registration attempts and failures and bad user experience during roaming where local networks cannot support these services.

It should be appreciated that network 100 may include multiple public land mobile networks (PLMNs), a home PLMN (HPLMN), and visiting PLMNs (VPLMNs). PLMNs typically refer to a geographical area covered by a mobile network operator for voice and data services to a mobile subscriber UE 106 using a SIM card 345. The home PLMN of a mobile subscriber is often referred to as the HPLMN, which has subscription profiles of subscribers in a home location register (HLR). Further, the UE 106 may roam to VPLMNs and try to obtain a service through the VPLMN. In roaming, a UE subscriber attaches to the core network via the access network. The roaming core network belongs to a PLMN, which may be referred to as the VPLMN.

As has been described, in one example embodiment, UE 106 may connect to network 100. As has been described the UE 106 may include: at least one antenna; at least one radio, wherein the at least one radio is configured to communicate with the network including a base station using the at least one antenna. The UE 106 may further include a SOC 300 with one or more processors 302.

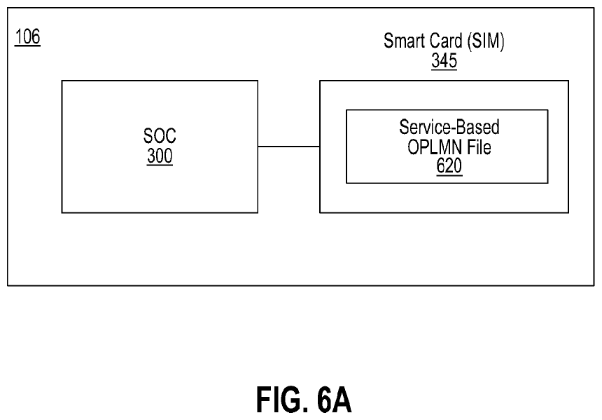

With additional reference to FIG. 6A, in one embodiment, UE 106 includes a SOC 300 including the at least one processor and a smart card or SIM card (Subscriber Identity Module) 345. The SIM card 345 may include a service-based operator public land mobile network (OPLMN) file 620 that includes a priority list of PLMNs, wherein each PLMN includes one or more supported services. The SOC 300 including processor 302 may be coupled to the SIM card 345 and the radio for communication as previously described.

The processor of the UE 100 may be configured to perform operations comprising: determining a service to request from an application; performing a PLMN selection from the service-based PLMN list of the service-based OPLMN file 620 of the SIM card 345; and based on the PLMN selection, proceeding with a service with the selected PLMN, as will be described in more detail hereafter.

In one embodiment, the PLMNs may include a home PLMN (HPLMN) and visiting PLMNs (VPLMNs). In one embodiment, the supported services include at least one of a location service, an emergency call, data, IP multi-media subsystem (IMS) short message service (SMS), IMS voice, circuit switched (CS) SMS, or CS voice. In one embodiment, the UE includes: a cellular watch, a stationary or mobile internet of things (IoT) sensor, a mobile IoT tracking device, or an emergency cellular fob.

It should be appreciated that in the existing 3GPP OPLMN specification, the OPLMN file in the SIM specifies only PLMN codes from highest to lowest priority and associated Access Technology Identifiers, without specifying supported services.

According to embodiments in the present disclosure, the UE 106 processor may be configured to perform PLMN selection by matching a requested service form the UE with available supported services from the service-based public land mobile network (PLMN) priority list of the SIM card 345, as will be described.

According to embodiments of the present disclosure, a service based PLMN priority list may be programmed in the SIM card 345. This new service-based OPLMN file 620 programmed in the SIM card 345 may indicate the availability of services provided by a network (PLMN, VPLMN) that the UE 106 is roaming to.

With additional reference to FIG. 6B, an example of the service-based OPLMN file 620 is illustrated. The service-based OPLMN file 620 includes existing components: Identifier, Structure, File Size, Update Activity, Access Conditions, etc. Further, the OPLMN file 620 includes (n) PLMNs. For example, 1^{st} PLMN 622, with a 1^{st} PLMN Access Technology Identifier 625, and the Supported Services of the 1^{st} PLMN 627. This same information is defined for each PLMN up to the n-th PLMN. Therefore, any number (n) of PLMNs and their Supported Services can be programmed in the Service-Based OPLMN file 620 of the SIM card.

Further, with additional reference to FIG. 6C, examples of the PLMN supported services 630 are described. In one example embodiment, the PLMN supported services may include location service, an emergency call, data, IP multi-media subsystem (IMS) short message service (SMS), IMS voice, circuit switched (CS) SMS, or CS voice. Each of these PLMN supported services may defined for each PLMN. This is just an example list of services and other services may be included or excluded. Also, a reserved file may be present.

In one embodiment, a UE 100 under the control of its processor may perform PLMN selection by matching a requested service (e.g., IMS SMS) with available supported services 630 for a PLMN from the service-based public land mobile network (PLMN) priority list 620 of the SIM card.

As an example, in one embodiment, the UE 100 processor may be configured to perform the PLMN selection by matching the requested service (e.g., IMS SMS) with available supported services 630 from the service-based public land mobile network (PLMN) priority list 620 of the SIM card based upon a received network broadcast of PLMNs and before registering with a PLMN. This may occur when the UE is in an idle mode. Also, the UE 100 may perform new PLMN selection at any time based on a new application service type requested.

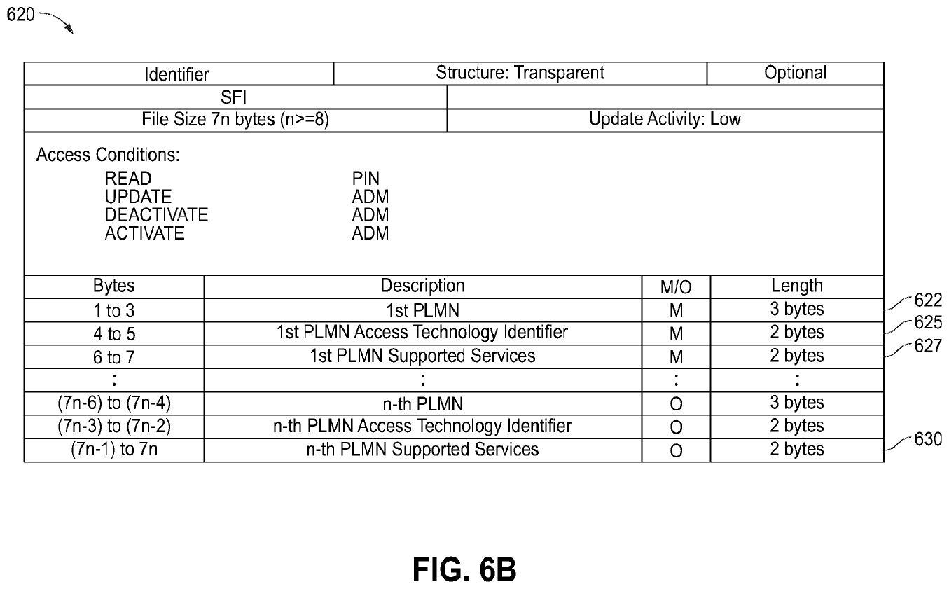

With brief additional reference to FIG. 7, an example method in a flow diagram is described. At block 710 a service to request from an application of the UE is determined. Next, a public land mobile network (PLMN) selection is performed from the service-based PLMN list 620 of the SIM card, in which, the service-based PLMN list includes a priority list of PLMNs, wherein each PLMN includes one or more supported services (e.g., location service, an emergency call, data, IMS SMS, IMS voice, CS SMS, or CS voice); and based on the PLMN selection, proceeding with the service with the selected PLMN. In one embodiment, the PLMNs include a home PLMN (HPLMN) and visiting PLMNs (VPLMNs).

As an example, the UE 100 may be roaming and a UE application for a requested service of IMS SMS is requested by the UE. The UE 100 receives network broadcast from various PLMNs and VPLMNs. The UE is configured to perform the PLMN selection by matching the requested service (e.g., IMS SMS) with available supported services 630 from the service-based public land mobile network (PLMN) priority list 620 of the SIM card based upon a received network broadcast of PLMNs. The supported services 630 may be considered to be a system information block (SIB) message that indicates the availability of services as well as services that are barred. In one embodiment, the network 100 indicates whether services based PLMN list or list of services available are provided via periodic broadcast basis or on-demand basis SIB. This occurs before registering with a PLMN. This may occur when the UE is in an idle mode. Based on the PLMN priority list 620 various PLMNs may not support the service, whereas one or more PLMNs may support the service, as set forth in the PLMN priority list 620. Based on PLMN priority list 620, the UE may select an appropriate PLMN to enable the IMS SMS service. Therefore, this new service-based OPLMN file 620 programmed in the SIM card 345 may indicate the availability of services provided by a network (PLMN, VPLMN) that the UE 106 is roaming to. Although IMS SMS service is given as an example, any sort of service may be requested and searched for (e.g., location service, emergency call, data, IMS voice, IMS SMS, CS SMS, CS voice, etc.).

As examples, the UE may often be a cellular watch, a stationary or mobile internet of things (IoT) sensor, a mobile IoT tracking device, or an emergency cellular fob and may want to request such services as-location service, an emergency call, data, IMS SMS, IMS voice, which are not always supported by some OPLMNs. The previously described method aids in the selection of such services based on the service-based OPLMN file 620 programmed in the SIM card 345. At the same time, older standard services such CS SMS and CS voice are also supported.

The previously described methods and apparatuses implement methods and processes at both the UE level and at the network level to solve the issue that, in standard cellular communication networks, there is a lack of an efficient way for network service discovery before registration and after reject, for newer types of services (e.g., IMS voice, IMS SMS, location service, emergency services, data) for newer wearable and IoT UEs, which results in excessive registration attempts and failures and bad user experience during roaming where local networks cannot support these services.

Another set of methods and apparatuses are hereafter disclosed for use in a communication network to implement service-based public land mobile network (PLMN) selection and registration for a user equipment (UE). The methods and apparatuses disclosed provide more granular service-based registration requests from the UE to the network and service-based registration acceptance from the network to the UE.

The methods and apparatuses hereafter disclosed are related to roaming cases. In roaming cases, along with registration reject, an HPLMN shall pass along new information elements (IEs) to the UE (e.g., in a transparent container) that include: what services are accepted and what services are rejected in the new IE; and a list of roaming VPLMNs in current location, with preferred radio access technologies (RATs) and their services supported in the roaming agreement in the new IE. The UE can then attempt new network registration on other VPLMNs based on the service/RAT provided by the VPLMNs.

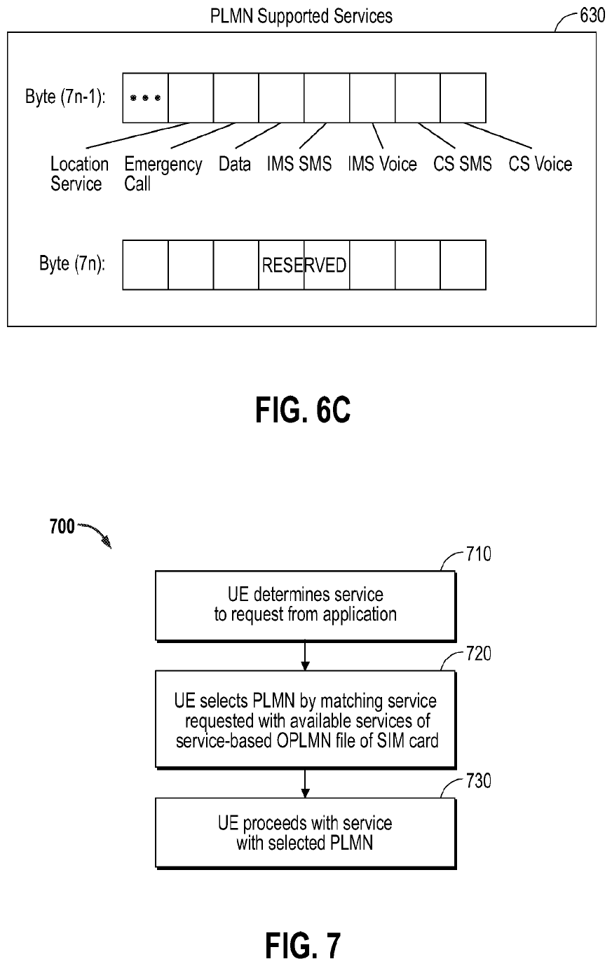

With reference to FIG. 8, a method to connect a user equipment (UE) to a network including a public land mobile network (PLMN), a home PLMN (HPLMN), and a visiting PLMN (VPLMN) is disclosed in a process 800.

For example, a UE may be roaming and the UE transmits an IE in a registration request to a network (a PLMN) including a service that the UE intends to use or that the UE is interested in (e.g., IMS voice, IMS SMS, location service, emergency services, data) initiated by a UE application (block 802). This registration request and service request is rejected by the network (PLMN) (block 805). Based upon the rejection of the services requested from the PLMN, the HPLMN sends to the UE a new IE and also sends to VPLMNs that are designated to accept the service request IEs about the service request (block 810). The new IE includes the one or more services requested by the UE that are accepted or rejected by VPLMNs (block 820). In particular, the new IE includes a list of roaming VLPMNs in the current location of the UE with preferred RATs and services that are supported (block 830). In this way, the UE can then attempt new network registration on the requested service or services that are accepted and provided by a VPLMN (block 840). Accordingly, the UE can register with a VPLMN providing the one or more of the services (e.g., IMS voice, IMS SMS, location service, emergency services, data) requested.

As an example, the HPLMN may maintain a database of VPLMNs with accepted or rejected services for the UE, such that the HPLMN prepares and transmits the new IE of the one or more services requested that are accepted or rejected by the VPLMNs to the UE. The HPLMN may be a computing device including a transceiver and a processor, in which, the processor performs operations including: receiving the IE in the registration request message from the roaming UE requesting the one or more services that were rejected by the PLMN; and then sending to the UE, the new IE of the one or more services requested that are accepted or rejected by VPLMNs, such that the UE can then attempt network registration with a VPLMN providing one or more of the services requested that are acceptable. Therefore, the HPLMN maintains a database of VPLMNs with accepted or rejected services for the UE, such that the processor of the HPLMN performs operations of: comparing one or more services requested by the UE with accepted or rejected services of VPLMNs accessible by the UE in the database to determine the accepted or rejected services of VPLMNs accessible by the UE; preparing a new IE of the one or more services requested that are accepted or rejected by VPLMNs accessible by the UE; and transmitting the new IE to the UE.

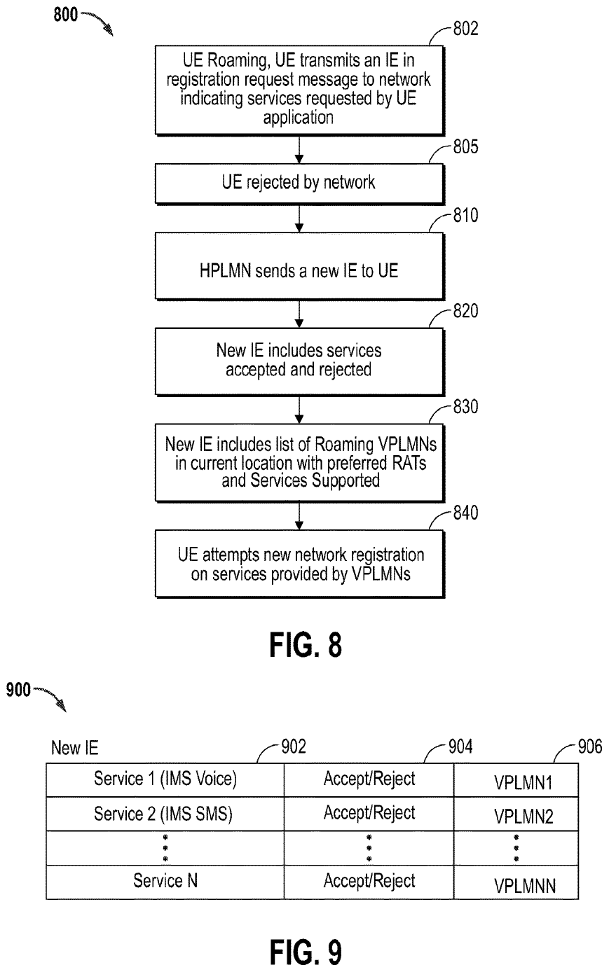

Referring to FIG. 9, a diagram illustrating a new IE 900 that may be prepared by the HPLMN and transmitted to the UE is provided. As shown various services 902 (e.g., IMS voice, IMS voice, . . . Service N) may be provided in the new IE 900 and for each service an accept/reject designation 904 is associated with the service and a VPLMN 906 (e.g., VPLMN1, VPLMN2, . . . VPLMNN) that accepts/rejects these services is in the new UE. It should be appreciated that this is a just example and any service (e.g., location service, an emergency call, data, IMS SMS, IMS voice, CS SMS, or CS voice, etc.) may be designated as accepted/rejected by any of the VPLMNs that the HPLMN prepares in the new IE.

Based upon this new IE 900 generated by HPLMN that is sent to the UE that includes one or more services requested by the UE that are accepted or rejected by VPLMNs, the UE can then attempt new network registration on the requested service or services that are accepted and provided by a VPLMN. Accordingly, the UE can register with a VPLMN providing the one or more of the services (e.g., IMS voice, IMS SMS, location service, emergency services, data) requested. In particular, the new IE includes a list of roaming VLPMNs in the current location of the UE with preferred RATs and services that are supported by VPLMNs based on roaming agreements. It should be appreciated that service may be rejected by VLPMNs because there is no subscription or a subscription has expired.

As an example, the UE may be roaming and a UE application for a requested service of IMS voice is requested by the UE. The UE transmits an IE in a registration request to a PLMN of the network that includes a service request for IMS voice initiated by the UE application. This registration request and service request is rejected by the PLMN. Based upon the rejection of the services requested from the PLMN, the HPLMN sends to the UE a new IE that includes the one or more services requested by the UE that are accepted or rejected by VPLMNs. As an example, as shown in FIG. 9, Service 1 for IMS voice 902 may be accepted 904 by VPLMN 1 906. As has been described, the new IE includes a list of roaming VLPMNs in the current location of the UE with preferred RATs and services that are supported. Based upon this, the UE can then attempt new network registration on the requested service IMS voice 902 that is accepted and provided by VPLMN 1 906. Accordingly, the UE can register with a VPLMN1 providing the service IMS voice 902 requested.

As another example, the UE may be roaming and a UE application for a requested service of IMS SMS is requested by the UE. The UE transmits an IE in a registration request to a PLMN of the network that includes a service request for IMS SMS initiated by the UE application. This registration request and service request is rejected by the PLMN. Based upon the rejection of the services requested from the PLMN, the HPLMN sends to the UE a new IE that includes the one or more services requested by the UE that are accepted or rejected by VPLMNs. As an example, as shown in FIG. 9, Service 2 for IMS SMS 902 may be accepted 904 by VPLMN 2 906. As has been described, the new IE includes a list of roaming VLPMNs in the current location of the UE with preferred RATs and services that are supported. Based upon this, the UE can then attempt new network registration on the requested service IMS SMS 902 that is accepted and provided by VPLMN 2 906. Accordingly, the UE can register with a VPLMN2 providing the service IMS SMS 902 requested.

As examples, the UE may often be a cellular watch, a stationary or mobile internet of things (IoT) sensor, a mobile IoT tracking device, or an emergency cellular fob and may want request such services as-location service, an emergency call, data, IMS SMS, IMS voice, which are not always supported by some PLMNs. The previously described method aids in the selection of such services based on an HPLMN that maintains a database of VPLMNs that provide services for the roaming UE and that can send a new IE to the UE such that the UE can implement the service with the VPLMN. At the same time, older standard services such CS SMS and CS voice are also supported with this method.

The previously described methods and apparatuses implement methods and processes at both the UE level and at the network level to solve the issue that, in standard cellular communication networks, there is a lack of an efficient way for network service discovery before registration and after reject, for newer types of services (e.g., IMS voice, IMS SMS, location service, emergency services, data) for newer wearable and IoT UEs, which results in excessive registration attempts and failures and bad user experience during roaming where local networks cannot support these services.

The methods and apparatuses disclosed are for use in a communication network to implement service-based public land mobile network (PLMN) selection and registration for a user equipment (UE). The methods and apparatuses disclosed provide more granular service-based registration requests from the UE to the network and service-based registration acceptance from the network to the UE. The methods and apparatuses implement methods and processes at both the UE level and at the network level to solve the issue that occurs in standard cellular communication networks, where there is a lack of an efficient way for network service discovery before registration and after reject, for newer types of services (e.g., IMS voice, IMS SMS, location service, emergency services) for newer wearable and IoT UEs, which results in excessive registration attempts and failures and bad user experience during roaming where local networks cannot support these services.

The previously described methods and apparatuses implement methods and processes at both the UE level and at the network level to solve these issues.

Portions of what was described above may be implemented with logic circuitry such as a dedicated logic circuit or with a microcontroller or other form of processing core that executes program code instructions. Thus processes taught by the discussion above may be performed with program code such as machine-executable instructions that cause a machine that executes these instructions to perform certain functions. In this context, a “machine” may be a machine that converts intermediate form (or “abstract”) instructions into processor specific instructions (e.g., an abstract execution environment such as a “virtual machine” (e.g., a Java Virtual Machine), an interpreter, a Common Language Runtime, a high-level language virtual machine, etc.), and/or, electronic circuitry disposed on a semiconductor chip (e.g., “logic circuitry” implemented with transistors) designed to execute instructions such as a general-purpose processor and/or a special-purpose processor. Processes taught by the discussion above may also be performed by (in the alternative to a machine or in combination with a machine) electronic circuitry designed to perform the processes (or a portion thereof) without the execution of program code. For example, the described operations may be stored as instructions on a non-transitory computer readable medium for execution by a computer.

The present invention also relates to an apparatus for performing the operations described herein. This apparatus may be specially constructed for the required purpose, or it may comprise a general-purpose computer selectively activated or reconfigured by a computer program stored in the computer. Such a computer program may be stored in a computer readable storage medium, such as, but is not limited to, any type of disk including floppy disks, optical disks, CD-ROMs, and magnetic-optical disks, read-only memories (ROMs), RAMS, EPROMS, EEPROMs, magnetic or optical cards, or any type of media suitable for storing electronic instructions, and each coupled to a computer system bus.

A machine readable medium includes any mechanism for storing or transmitting information in a form readable by a machine (e.g., a computer). For example, a machine readable medium includes read only memory (“ROM”); random access memory (“RAM”); magnetic disk storage media; optical storage media; flash memory devices; etc.

An article of manufacture may be used to store program code. An article of manufacture that stores program code may be embodied as, but is not limited to, one or more memories (e.g., one or more flash memories, random access memories (static, dynamic or other)), optical disks, CD-ROMs, DVD ROMs, EPROMS, EEPROMs, magnetic or optical cards or other type of machine-readable media suitable for storing electronic instructions. Program code may also be downloaded from a remote computer (e.g., a server) to a requesting computer (e.g., a client) by way of data signals embodied in a propagation medium (e.g., via a communication link (e.g., a network connection)).

The preceding detailed descriptions are presented in terms of algorithms and symbolic representations of operations on data bits within a computer memory. These algorithmic descriptions and representations are the tools used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be kept in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as “selecting,” “determining,” “receiving,” “forming,”“grouping,” “aggregating,” “generating,” “removing,” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The processes and displays presented herein are not inherently related to any particular computer or other apparatus. Various general-purpose systems may be used with programs in accordance with the teachings herein, or it may prove convenient to construct a more specialized apparatus to perform the operations described. The required structure for a variety of these systems will be evident from the description below. In addition, the present invention is not described with reference to any particular programming language. It will be appreciated that a variety of programming languages may be used to implement the teachings of the invention as described herein.

The foregoing discussion merely describes some exemplary embodiments of the present invention. One skilled in the art will readily recognize from such discussion, the accompanying drawings and the claims that various modifications can be made without departing from the spirit and scope of the invention.

1. A user equipment (UE) to connect to a network comprising:
at least one antenna;
at least one radio, wherein the at least one radio is configured to communicate with the network including a base station using the at least one antenna;
a SIM (Subscriber Identity Module) card including a service-based public land mobile network (PLMN) list including a priority list of PLMNs, wherein each PLMN of the priority list includes one or more supported services;
at least one processor coupled to the at least one radio and the SIM card, wherein the at least one processor is configured to perform operations comprising:
determining a service to request from an application;
performing a PLMN selection of a selected PLMN from the service-based PLMN list of the SIM card; and
based on the PLMN selection, proceeding with the service with the selected PLMN.

2. The UE of claim 1, wherein the priority list of PLMNs include a home PLMN (HPLMN) and one or more visiting PLMNs (VPLMNs).

3. The UE of claim 1, wherein the one or more supported services include at least one of a location service, an emergency call, data, IP multi-media subsystem (IMS) short message service (SMS), IMS voice, circuit switched (CS) SMS, or CS voice.

4. The UE of claim 1, wherein the UE includes: a cellular watch, a stationary or mobile internet of things (IoT) sensor, a mobile IoT tracking device, or an emergency cellular fob.

5. The UE of claim 1, wherein, the at least one processor is configured to perform the PLMN selection by matching the requested service with available supported services from the service-based PLMN list of the SIM card.

6. The UE of claim 5, wherein, the at least one processor is configured to perform the PLMN selection by matching the requested service with available supported services from the service-based PLMN list of the SIM card during an idle mode of the UE.

7. The UE of claim 5, wherein, the at least one processor is configured to perform the PLMN selection by matching the requested service with available supported services from the service-based PLMN list of the SIM card based upon a received network broadcast of PLMNs and before registering with a PLMN.

8. A method to connect a user equipment (UE) to a network comprising:
determining a service to request from an application;
performing a public land mobile network (PLMN) selection of a selected PLMN from a service-based PLMN list of a Subscriber Identity Module (SIM) card, wherein the SIM card includes the service-based PLMN list including a priority list of PLMNs, wherein each PLMN of the priority list includes one or more supported services; and
based on the PLMN selection, proceeding with the service with the selected PLMN.

9. The method of claim 8, wherein the priority list of PLMNs include a home PLMN (HPLMN) and one or more visiting PLMNs (VPLMNs).

10. The method of claim 8, wherein the one or more supported services include at least one of a location service, an emergency call, data, IP multi-media subsystem (IMS) short message service (SMS), IMS voice, circuit switched (CS) SMS, or CS voice.

11. The method of claim 8, wherein the UE includes: a cellular watch, a stationary or mobile internet of things (IoT) sensor, a mobile IoT tracking device, or an emergency cellular fob.

12. The method of claim 8, wherein performing the PLMN selection includes matching the requested service with available supported services from the service-based PLMN list of the SIM card.

13. The method of claim 12, wherein the performing the PLMN selection by matching the requested service with available supported services from the service-based PLMN list of the SIM card occurs during an idle mode of the UE.

14. The method of claim 12, wherein, the performing the PLMN selection by matching the requested service with available supported services from the service-based PLMN list of the SIM card is based upon a received network broadcast of PLMNs and before registering with a PLMN.

15-20. (canceled)

21. A computing device of a home public land mobile network PLMN (HPLMN) to connect a user equipment (UE) to a visiting PLMN (VPLMN) comprising:
a transceiver; and
at least one processor coupled to the transceiver, wherein the at least one processor is configured to perform operations comprising:
receiving a first information element (IE) in a registration request message from the UE requesting one or more services that were rejected by one or more PLMNs; and
sending to the UE, a second IE of the one or more services requested that are accepted or rejected by one or more VPLMNs, wherein the UE is configured to attempt network registration with a VPLMN providing one or more of the services requested that is accepted.

22. The computing device of claim 21, wherein the one or more services include at least one of a location service, an emergency call, data, IP multi-media subsystem (IMS) short message service (SMS), IMS voice, circuit switched (CS) SMS, or CS voice.

23. The computing device of claim 21, wherein the UE includes: a cellular watch, a stationary or mobile internet of things (IoT) sensor, a mobile IoT tracking device, or an emergency cellular fob.

24. The computing device of claim 21, wherein the computing device of the HPLMN maintains a database of VPLMNs with accepted or rejected services for the UE, and wherein the at least one processor is configured to perform operations comprising:
comparing one or more services requested by the UE with accepted or rejected services of one or more VPLMNs accessible by the UE in the database to determine the accepted or rejected services of the one or more VPLMNs accessible by the UE;
preparing the second IE of the one or more services requested by the UE that are accepted or rejected by the one or more VPLMNs accessible by the UE; and
transmitting the second IE to the UE.

25. The computing device of claim 24, wherein the second IE generated by HPLMN includes one or more roaming VLPMNs that are in a current location of the UE.

26. The computing device of claim 21, wherein the second IE generated by HPLMN further includes preferred radio access technologies (RATs) for the UE and one or more VLPMNs that are supported by one or more roaming agreements.
